(19) United States
(12) Patent Application Publication
(10) Pub. No.: US 2007/0233643 A1
(43) Pub. Date: Oct. 4, 2007

(54) Apparatus and method for protecting access to phishing site

(76) Inventors: Jung Min Kang, Yuseong-Gu (KR); Ki Wook Sohn, Yuseong-gu (KR)

Correspondence Address: LADAS & PARRY LLP, 224 SOUTH MICHIGAN AVENUE, SUITE 1600, CHICAGO, IL, 60604, US

(21) Appl. No.: 11/487,899

(22) Filed: Jul. 17, 2006

(30) Foreign Application Priority Data
Mar. 29, 2006 (KR) 2006-28234

(51) Int. Cl. G06F 17/30

(52) U.S. Cl. 707/2

(57) ABSTRACT

An apparatus and method for protecting an access to a phishing site are provided. When accessing a phishing site, an access URL information is acquired using a pcap library. A previously established phishing site database is retrieved and it is reported that the accessed site is the phishing site when an URL information coinciding with an access URL exists. When the URL coinciding with the access URL does not exist, a similarity value with respect to an URL stored in a normal site database is calculated and it is reported that the accessed site is the phishing site when the calculated similarity value is more than a set value. Accordingly, the apparatus and method for protecting the access to the phishing site can be operated on a user PC for preventing the leakage of the private data, and can also be developed as an individual network equipment and used as a system for protecting the access to the phishing site.

### BACKGROUND OF THE INVENTION

1. Field of the Invention

The present invention relates to an apparatus and method for protecting an access to a phishing site, and more particularly, to an apparatus and method for protecting an access to a phishing site, capable of disconneting an access to an unintended phishing site.

2. Description of the Related Art

Phishing is a hacking technique that attempts to acquire credit card information or account information of the related financial institutions by sending fraudulent e-mails to unspecific persons requesting the e-mail receivers: to modify the credit card or the bank accounts because of some problems. The phishing is a compound word of “private data” and “fishing”, meaning a clandestine stealing of the private data like going fishing. That is, the phishing is a new kind of Internet financial fraud. A phisher who intends to illegitimately acquire private data sends a fraudulent e-mail to unspecific persons and lures them into a fraudulent website, and then steals their credit card and bank account information and abuses the acquired information.

One of phishing preventing methods is to register sites having previous record in the black list and indicate that the accessed site is the phishing site when the user connects the listed sites. Another method is to indicate the risk level of the website and protect the access to the site, evaluated as the phishing site. In a similar manner to a misuse detection method of an Intrusion Detection System (IDS), theses methods retain information about the abnormal phishing sites and report that the site is the phishing site when the site accessed by the user coincides with the registered site. However, these approaches have the following disadvantages.

First, it is impossible to cope with the access to an unregistered abnormal or new phishing site.

Second, the list of the phishing sites must be updated every time.

Third, the phishing protection mechanism may be entirely broken when the central management of the phishing sites is broken.

### SUMMARY OF THE INVENTION

Accordingly, the present invention is directed to an apparatus and method for protecting an access to a phishing site, which substantially obviates one or more problems due to limitations and disadvantages of the related art.

It is an object of the present invention to provide an apparatus and method for protecting an access to a phishing site, in which when a user accesses a site, a reference monitor identifies an accessed site, and gives a phishing warning when a user access URL exists in a previously stored phishing site database. Also, when the access URL does not exist, a similarity with respect to the URL information stored in a normal site database is compared and it is reported that the accessed site is the phishing site when the similarity value is more than a predetermined threshold value.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for protecting an access to a phishing site, including: a transfer URL access executing unit for requesting an actual URL information of an accessed site to a pcap information parsing unit; the pcap information parsing unit for acquiring an access URL information by parsing a pcap information through a pcap library corresponding to the request of the transfer URL access executing unit, and transferring the acquired access URL information to the transfer URL access executing unit; a transfer URL access determining unit for receiving the access URL information from the transfer URL access executing unit, and determining whether or not the accessed site is the phishing site by using a retrieval result value transferred from a phishing site list managing unit and a transfer URL similarity checking unit; the phishing site list managing unit including a phishing site database managing a phishing site list, the phishing site list managing unit providing a retrieval result value corresponding to the request of the transfer URL access determining unit; and the transfer URL similarity checking unit includes a normal site database managing a normal site, the transfer URL similarity checking unit providing a similarity value by comparing a normal site data with an URL according to the request of the transfer URL access determining unit.

In another aspect of the present invention, there is provided a method for protecting an access to a phishing site, including: when accessing a phishing site, acquiring an access URL information using a pcap library; retrieving a previously established phishing site database and reporting that the accessed site is the phishing site when an URL information coinciding with an access URL exists; and when the URL coinciding with the access URL does not exist, calculating a similarity value with respect to an URL stored in a normal site database and reporting that the accessed site is the phishing site when the calculated similarity value is more than a set value.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 illustrates a framework of a reference monitor for protecting an access to a phishing site according to an embodiment of the present invention; and

FIG. 2 illustrates a network configuration of the reference monitor according to the embodiment of the present invention.

### DETAILED DESCRIPTION OF THE INVENTION

Reference will now be made in detail to the preferred embodiments of the present invention, examples of which are illustrated in the accompanying drawings.

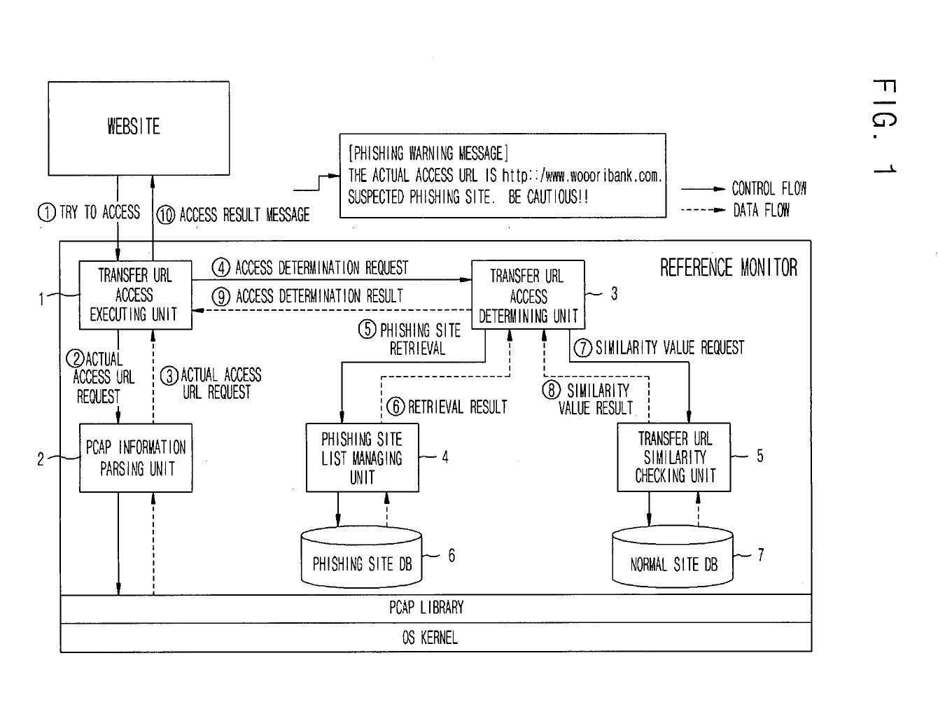

FIG. 1 illustrates a framework of a reference monitor for protecting an access to a phishing site according to an embodiment of the present invention.

Referring to FIG. 1, the reference monitor includes a transfer URL access executing unit 1, a pcap (packet capturing tool) information parsing unit 2, a transfer URL access determining unit 3, a phishing site list managing unit 4, and a transfer URL similarity checking unit 5.

When accessing a site, the transfer URL access executing unit 1 requests an actual URL information of the accessed site to the pcap information parsing unit 2. The pcap information parsing unit 2 acquires the access URL information by parsing the pcap information through a pcap library corresponding to the request of the transfer URL access executing unit 1. The transfer URL access determining unit 3 determines whether or not the accessed site is the phishing site by using the phishing site list managing unit 4 and the transfer URL similarity checking unit 5. The phishing site list managing unit 4 includes a phishing site database (DB) 6 and manages the list of phishing sites. The transfer URL similarity checking unit 5 includes a normal site DB 7 and extracts a similarity value by comparing normal site data with URL.

In operations \textcircled{1} to \textcircled{3}, when the user accesses a site, the transfer URL access executing unit I requests an actual URL information of the accessed site to the pcap information parsing unit 2 and acquires it. In operation \textcircled{4}, the transfer URL access executing unit 1 requests the transfer URL access determining unit 3 to determine whether or not the acquired URL information is the phishing site. In operations \textcircled{5} and \textcircled{6}, to check whether or not the acquired URL information is the phishing site, the transfer URL access determining unit 3 requests the phishing site list -managing unit 4 to retrieve whether or not an URL corresponding to the user access URL exists, and acquires the retrieval result. Then, in operations \textcircled{7} and \textcircled{8}, when there is no URL information corresponding to the user access URL, the transfer URL access determining unit 3 requests the transfer URL similarity checking unit 5 to send a similarity value and acquires it. In operations \textcircled{9} and \textcircled{10}, the transfer URL similarity checking unit 5 extracts the similarity value by comparing the inputted URL information with the URL of the normal site DB 7. Then, using the similarity value, the access determination result is transferred to the transfer URL access executing unit 1 and user's access permission/denial are executed.

The algorithm for comparing the inputted URL information with the URL of the normal site DB 7 in order for the transfer URL similarity checking unit 5 to calculate the similarity value utilizes a similarity checking algorithm used in Bioinformatics fields.

Like this, the reference monitor acquires the access URL information using the pcap library when the users access the phishing site luring them, retrieves the previously established phishing site DB, and reports that the accessed site is the phishing site when the URL information coinciding with the access URL exists. On the contrary, when the URL information coinciding with the access URL does not exist, the reference monitor calculates the similarity value with respect to the URL stored in the normal site DB, and reports that the accessed site is the phishing site when the similarity value is more than a predetermined threshold value.

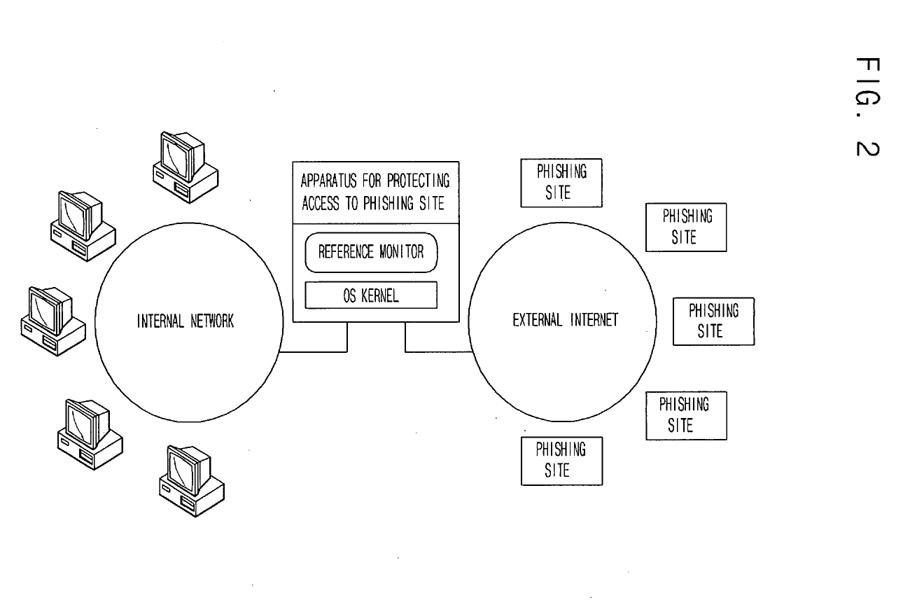

FIG. 2 illustrates a network configuration of the reference monitor according to the embodiment of the present invention.

Specifically, FIG. 2 illustrates the network configuration of the reference monitor when the reference monitor concept is expanded to a network equipment. When accessing from an internal network to the phishing site, an operation of the network equipment for protecting the access to the phishing site-is identical to the process of protecting the access to the phishing site, except the process of acquiring the URL information of the user access using the sniffing scheme.

As described above, the apparatus and method for protecting the access to the phishing site can be operated on a user PC for preventing the leakage of the private data, and can also be developed as an individual network equipment and used as a system for protecting the access to the phishing site.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for protecting an access to a phishing site, comprising:
a transfer URL access executing unit for requesting an actual URL information of an accessed site to a pcap information parsing unit;
the pcap information parsing unit for acquiring an access URL information by parsing a pcap information through a pcap library corresponding to the request of the transfer URL access executing unit, and transferring the acquired access URL information to the transfer URL access executing unit;
a transfer URL access determining unit for receiving the access URL information from the transfer URL access executing unit, and determining whether or not the accessed site is the phishing site by using a retrieval result value transferred from a phishing site list managing unit and a transfer URL similarity checking unit;
the phishing site list managing unit including a phishing site database managing a phishing site list, the phishing site list managing unit providing a retrieval result value corresponding to the request of the transfer URL access determining unit; and
the transfer URL similarity checking unit includes a normal site database managing a normal site, the transfer URL similarity checking unit providing a similarity value by comparing a normal site data with an URL according to the request of the transfer URL access determining unit.

2. The apparatus of claim 1, wherein the apparatus is installed in an internal network input terminal.

3. The apparatus of claim 1, wherein the apparatus is installed in a personal terminal.

4. A method for protecting an access to a phishing site, comprising:
when accessing a phishing site, acquiring an access URL information using a pcap library;
retrieving a previously established phishing site database and reporting that the accessed site is the phishing site when an URL information coinciding with an access URL exists; and
when the URL coinciding with the access URL does not exist, calculating a similarity value with respect to an URL stored in a normal site database and reporting that the accessed site is the phishing site when the calculated similarity value is more than a set value.

5. The method of claim 1, wherein an algorithm for calculating the similarity value utilizes a similarity checking algorithm used in a Bioinformatics field.
